(19) United States
(12) Patent Application Publication
(10) Pub. No.: US 2025/0292762 A1
(43) Pub. Date: Sep. 18, 2025

(54) Apparatus, Methods and Computer Programs for Spatial Rendering of Reverberation

(71) Applicant: Nokia Technologies Oy, Espoo (FI)

(72) Inventors: Antti Johannes Eronen, Tamoere (FI); Mikko-Ville Laitinen, Espoo (FI)

(21) Appl. No.: 18/861,921

(22) PCT Filed: Apr. 11, 2023
(86) PCT No.: PCT/EP2023/059365

§ 371 Date: Oct. 31, 2024

(30) Foreign Application Priority Data
May 3, 2022 (GB) 2206430.7

(51) Int. Cl. G10K 15/12; H04S 7/00

(52) U.S. Cl. CPC G10K 15/12; H04S 7/305

(57) ABSTRACT

An apparatus for applying reverberation to at least one audio signal, the apparatus including circuitry configured to: obtain the at least one audio signal; obtain a number of sound reproduction positions for playback audio in relation to a listening position; determine a reverberator including a number of channels, wherein the number of channels is configured with at least two respective delay lines having different delays; assign the reverberator channels to the sound reproduction positions based on the delays of the number of channels; and process the at least one audio signal with the reverberator based on the assigned channels to generate reverberated playback audio signals for the listening position.

### FIELD

The present application relates to apparatus and methods for spatial rendering of reverberation, but not exclusively for spatial rendering of reverberation in augmented reality and/or virtual reality apparatus.

### BACKGROUND

Reverberation refers to the persistence of sound in a space after the actual sound source has stopped. Different spaces are characterized by different reverberation characteristics. For conveying spatial impression of an environment, reproducing reverberation perceptually accurately is important. Room acoustics are often modelled with individually synthesized early reflection portion and a statistical model for the diffuse late reverberation. FIG. 1 depicts an example of a synthesized room impulse response where the direct sound 101 is followed by discrete early reflections 103 which have a direction of arrival (DOA) and diffuse late reverberation 105 which can be synthesized without any specific direction of arrival. The delay d1(t) 102 in FIG. 1 can be seen to denote the direct sound arrival delay from the source to the listener and the delay d2(t) 104 can denote the delay from the source to the listener for one of the early reflections (in this case the first arriving reflection).

One method of reproducing reverberation is to utilize a set of N loudspeakers (or virtual loudspeakers reproduced binaurally using a set of head-related transfer functions (HRTF)). The loudspeakers are positioned around the listener somewhat evenly. Mutually incoherent reverberant signals are reproduced from these loudspeakers, producing a perception of surrounding diffuse reverberation.

The reverberation produced by the different loudspeakers has to be mutually incoherent. In a simple case the reverberations can be produced using the different channels of the same reverberator, where the output channels are uncorrelated but otherwise share the same acoustic characteristics such as RT60 time and level (specifically, the diffuse-to-direct ratio or reverberant-to-direct ratio or diffuse-to-total ratio or diffuse-to-source ratio or any other suitable parameter for representing reverberation energy or level). Such uncorrelated outputs sharing the same acoustic characteristics can be obtained, for example, from the output taps of a Feedback-Delay-Network (FDN) reverberator with suitable tuning of the delay line lengths, or from a reverberator based on using decaying uncorrelated noise sequences by using a different uncorrelated noise sequence in each channel. In this case, the different reverberant signals effectively have the same features, and the reverberation is typically perceived to be similar to all directions.

### SUMMARY

There is provided according to a first aspect an apparatus for applying reverberation to at least one audio signal, the apparatus comprising means configured to: obtain the at least one audio signal; obtain a number of sound reproduction positions for playback audio in relation to a listening position; determine a reverberator comprising a number of channels, wherein the number of channels is configured with at least two respective delay lines having different delays; assign the reverberator channels to the sound reproduction positions based on the delays of the number of channels; and process the at least one audio signal with the reverberator based on the assigned channels to generate reverberated playback audio signals for the listening position.

The means may be further configured to: determine directional filter pairs associated with each of the sound reproduction positions for playback audio; and filter the reverberated playback audio signals with the associated directional filter pairs to generate reverberated playback binaural audio signals.

The means configured to assign the channels to the sound reproduction positions based on the delays of the channels may be configured to: order the channels based on the delays; and assign the channels to the sound reproduction positions based on the ordering of the channels.

The means configured to assign the channels to the sound reproduction positions based on the delays may be configured to assign channels with similar delay lengths to sound reproduction positions distributed away from each other.

The means configured to assign channels with similar delay lengths to sound reproduction positions distributed away from each other may be configured to: assign a first of the ordered channels to a first sound reproduction position; and assign succeeding ordered channels to sound reproduction positions further than a threshold distance away from a preceding assigned sound reproduction position.

The means configured to assign succeeding ordered channels to sound reproduction positions further than a threshold distance away from the preceding assigned sound reproduction position may be configured to assign succeeding ordered channels to a currently unassigned sound reproduction position furthest away from an immediately preceding assigned sound reproduction position.

The means configured to assign the channels to the sound reproduction positions based on the delays may be configured to: determine the number of sound reproduction positions is fewer than the number of channels; and assign more than one channel to at least one of the sound reproduction positions such that each channel is assigned to one of the sound reproduction positions.

The means configured to assign the channels to the sound reproduction positions based on the delays may be configured to: determine the number of sound reproduction positions is greater than the number of reverberator channels; generate at least one further reverberator channel; and assign the at least one further reverberator channel to at least one of the sound reproduction positions which have not been assigned previously.

The means configured to determine the reverberator comprising the number of channels, wherein the number of channels is configured with respective delay lines having different delays may be configured to: obtain at least one dimension of a scene within which the reverberation is associated with; and determine at least one time delay for a reflection path based on the at least one dimension of the scene, wherein the delay-line delay is based the determined at least one time delay for the reflection path.

The means configured to assign the channels to the sound reproduction positions based on the delays may be configured to assign the channels to the sound reproduction positions further based on the at least one dimension of the scene.

The means configured to assign the channels to the sound reproduction positions further based on the at least one dimension of the scene may be configured to: select two initial directions from the sound reproduction positions based on a longest dimension of the scene, such that the two initial directions are separated by the longest dimension; assign a first channel to a first of the two initial directions from the sound reproduction positions; and assign a second channel to a second of the two initial directions from the sound reproduction positions, wherein the respective delay-line delay of the second channel is similar to or equal to the respective delay-line delay of the first channel and the respective delay-line delay of the second channel and the respective delay-line delay of the first channel are the two shortest delay delay-lines.

The means configured to assign the channels to the sound reproduction positions based on the delays may be configured to: assign a first ordered channel to a first sound reproduction position; and assign a succeeding ordered channel to an unassigned sound reproduction position a minimum distance away from a preceding assigned sound reproduction position.

The reverberator may comprise the number of reverberators, each of the number of reverberators comprising a single channel, and wherein the means configured to order the channels based on the delay-line delay may be configured to arrange the number of reverberators in the order of increasing delay-line delay.

The reverberator may comprise a feedback delay network reverberator.

The channels may be configured with respective delay lines having different delays.

The channels may be configured with respective delay lines having different delays which are made mutually prime.

According to a second aspect there is provided a method for an apparatus for applying reverberation to at least one audio signal, the method comprising: obtaining the at least one audio signal; obtaining a number of sound reproduction positions for playback audio in relation to a listening position; determining a reverberator comprising a number of channels, wherein the number of channels is configured with at least two respective delay lines having different delays; assigning the reverberator channels to the sound reproduction positions based on the delays of the number of channels; and processing the at least one audio signal with the reverberator based on the assigned channels to generate reverberated playback audio signals for the listening position.

The method may further comprise: determining directional filter pairs associated with each of the sound reproduction positions for playback audio; and filtering the reverberated playback audio signals with the associated directional filter pairs to generate reverberated playback binaural audio signals.

Assigning the channels to the sound reproduction positions based on the delays of the channels may comprise: ordering the channels based on the delays; and assigning the channels to the sound reproduction positions based on the ordering of the channels.

Assigning the channels to the sound reproduction positions based on the delays may comprise assigning channels with similar delay lengths to sound reproduction positions distributed away from each other.

Assigning channels with similar delay lengths to sound reproduction positions distributed away from each other may comprise: assigning a first of the ordered channels to a first sound reproduction position; and assigning succeeding ordered channels to sound reproduction positions further than a threshold distance away from a preceding assigned sound reproduction position.

Assigning succeeding ordered channels to sound reproduction positions further than a threshold distance away from the preceding assigned sound reproduction position may comprise assigning succeeding ordered channels to a currently unassigned sound reproduction position furthest away from an immediately preceding assigned sound reproduction position.

Assigning the channels to the sound reproduction positions based on the delays may comprise: determining the number of sound reproduction positions is fewer than the number of channels; and assigning more than one channel to at least one of the sound reproduction positions such that each channel is assigned to one of the sound reproduction positions.

Assigning the channels to the sound reproduction positions based on the delays may comprise: determining the number of sound reproduction positions is greater than the number of reverberator channels; generating at least one further reverberator channel; and assigning the at least one further reverberator channel to at least one of the sound reproduction positions which have not been assigned previously.

Determining the reverberator comprising the number of channels, wherein the number of channels is configured with respective delay lines having different delays may comprise: obtaining at least one dimension of a scene within which the reverberation is associated with; and determining at least one time delay for a reflection path based on the at least one dimension of the scene, wherein the delay-line delay is based the determined at least one time delay for the reflection path.

Assigning the channels to the sound reproduction positions based on the delays may comprise assigning the channels to the sound reproduction positions further based on the at least one dimension of the scene.

Assigning the channels to the sound reproduction positions further based on the at least one dimension of the scene may comprise: selecting two initial directions from the sound reproduction positions based on a longest dimension of the scene, such that the two initial directions are separated by the longest dimension; assigning a first channel to a first of the two initial directions from the sound reproduction positions; and assigning a second channel to a second of the two initial directions from the sound reproduction positions, wherein the respective delay-line delay of the second channel is similar to or equal to the respective delay-line delay of the first channel and the respective delay-line delay of the second channel and the respective delay-line delay of the first channel are the two shortest delay delay-lines.

Assigning the channels to the sound reproduction positions based on the delays may comprise: assigning a first ordered channel to a first sound reproduction position; and assigning a succeeding ordered channel to an unassigned sound reproduction position a minimum distance away from a preceding assigned sound reproduction position.

The reverberator may comprise the number of reverberators, each of the number of reverberators comprising a single channel, and wherein ordering the channels based on the delay-line delay may comprise arranging the number of reverberators in the order of increasing delay-line delay.

The reverberator may comprise a feedback delay network reverberator.

The channels may be configured with respective delay lines having different delays.

The channels may be configured with respective delay lines having different delays which are made mutually prime.

According to a third aspect there is provided an apparatus for applying reverberation to at least one audio signal, the apparatus comprising at least one processor and at least one memory including a computer program code, the at least one memory and the computer program code configured to, with the at least one processor, cause the apparatus at least to: obtain the at least one audio signal; obtain a number of sound reproduction positions for playback audio in relation to a listening position; determine a reverberator comprising a number of channels, wherein the number of channels is configured with at least two respective delay lines having different delays; assign the reverberator channels to the sound reproduction positions based on the delays of the number of channels; and process the at least one audio signal with the reverberator based on the assigned channels to generate reverberated playback audio signals for the listening position.

The apparatus may be further caused to: determine directional filter pairs associated with each of the sound reproduction positions for playback audio; and filter the reverberated playback audio signals with the associated directional filter pairs to generate reverberated playback binaural audio signals.

The apparatus caused to assign the channels to the sound reproduction positions based on the delays of the channels may be caused to: order the channels based on the delays; and assign the channels to the sound reproduction positions based on the ordering of the channels.

The apparatus caused to assign the channels to the sound reproduction positions based on the delays may be caused to assign channels with similar delay lengths to sound reproduction positions distributed away from each other.

The apparatus caused to assign channels with similar delay lengths to sound reproduction positions distributed away from each other may be caused to: assign a first of the ordered channels to a first sound reproduction position; and assign succeeding ordered channels to sound reproduction positions further than a threshold distance away from a preceding assigned sound reproduction position.

The apparatus caused to assign succeeding ordered channels to sound reproduction positions further than a threshold distance away from the preceding assigned sound reproduction position may be caused to assign succeeding ordered channels to a currently unassigned sound reproduction position furthest away from an immediately preceding assigned sound reproduction position.

The apparatus caused to assign the channels to the sound reproduction positions based on the delays may be caused to: determine the number of sound reproduction positions is fewer than the number of channels; and assign more than one channel to at least one of the sound reproduction positions such that each channel is assigned to one of the sound reproduction positions.

The means configured to assign the channels to the sound reproduction positions based on the delays may be configured to: determine the number of sound reproduction positions is greater than the number of reverberator channels; generate at least one further reverberator channel; and assign the at least one further reverberator channel to at least one of the sound reproduction positions which have not been assigned previously.

The means configured to determine the reverberator comprising the number of channels, wherein the number of channels is configured with respective delay lines having different delays may be configured to: obtain at least one dimension of a scene within which the reverberation is associated with; and determine at least one time delay for a reflection path based on the at least one dimension of the scene, wherein the delay-line delay is based the determined at least one time delay for the reflection path.

The means configured to assign the channels to the sound reproduction positions based on the delays may be configured to assign the channels to the sound reproduction positions further based on the at least one dimension of the scene.

The means configured to assign the channels to the sound reproduction positions further based on the at least one dimension of the scene may be configured to: select two initial directions from the sound reproduction positions based on a longest dimension of the scene, such that the two initial directions are separated by the longest dimension; assign a first channel to a first of the two initial directions from the sound reproduction positions; and assign a second channel to a second of the two initial directions from the sound reproduction positions, wherein the respective delay-line delay of the second channel is similar to or equal to the respective delay-line delay of the first channel and the respective delay-line delay of the second channel and the respective delay-line delay of the first channel are the two shortest delay delay-lines.

The means configured to assign the channels to the sound reproduction positions based on the delays may be configured to: assign a first ordered channel to a first sound reproduction position; and assign a succeeding ordered channel to an unassigned sound reproduction position a minimum distance away from a preceding assigned sound reproduction position.

The reverberator may comprise the number of reverberators, each of the number of reverberators comprising a single channel, and wherein the apparatus caused to order the channels based on the delay-line delay may be caused to arrange the number of reverberators in the order of increasing delay-line delay.

The reverberator may comprise a feedback delay network reverberator.

The channels may be configured with respective delay lines having different delays.

The channels may be configured with respective delay lines having different delays which are made mutually prime.

According to a fourth aspect there is provided an apparatus for applying reverberation to at least one audio signal, the apparatus comprising: obtaining circuitry configured to obtain the at least one audio signal; obtaining circuitry configured to obtain a number of sound reproduction positions for playback audio in relation to a listening position; determining circuitry configured to determine a reverberator comprising a number of channels, wherein the number of channels is configured with at least two respective delay lines having different delays; assigning circuitry configured to assign the reverberator channels to the sound reproduction positions based on the delays of the number of channels; and processing circuitry configured to process the at least one audio signal with the reverberator based on the assigned channels to generate reverberated playback audio signals for the listening position.

According to a fifth aspect there is provided a computer program comprising instructions [or a computer readable medium comprising program instructions] for causing an apparatus for applying reverberation to at least one audio signal to perform at least the following: obtain the at least one audio signal; obtain a number of sound reproduction positions for playback audio in relation to a listening position; determine a reverberator comprising a number of channels, wherein the number of channels is configured with at least two respective delay lines having different delays; assign the reverberator channels to the sound reproduction positions based on the delays of the number of channels; and process the at least one audio signal with the reverberator based on the assigned channels to generate reverberated playback audio signals for the listening position.

According to a sixth aspect there is provided a non-transitory computer readable medium comprising program instructions for causing an apparatus, for applying reverberation to at least one audio signal, to perform at least the following: obtain the at least one audio signal; obtain a number of sound reproduction positions for playback audio in relation to a listening position; determine a reverberator comprising a number of channels, wherein the number of channels is configured with at least two respective delay lines having different delays; assign the reverberator channels to the sound reproduction positions based on the delays of the number of channels; and process the at least one audio signal with the reverberator based on the assigned channels to generate reverberated playback audio signals for the listening position.

According to a seventh aspect there is provided an apparatus, for applying reverberation to at least one audio signal, comprising: means for obtaining the at least one audio signal; means for obtaining a number of sound reproduction positions for playback audio in relation to a listening position; means for determining a reverberator comprising a number of channels, wherein the number of channels is configured with at least two respective delay lines having different delays; means for assigning the reverberator channels to the sound reproduction positions based on the delays of the number of channels; and means for processing the at least one audio signal with the reverberator based on the assigned channels to generate reverberated playback audio signals for the listening position.

According to an eighth aspect there is provided a computer readable medium comprising program instructions for causing an apparatus, for applying reverberation to at least one audio signal, to perform at least the following: obtain the at least one audio signal; obtain a number of sound reproduction positions for playback audio in relation to a listening position; determine a reverberator comprising a number of channels, wherein the number of channels is configured with at least two respective delay lines having different delays; assign the reverberator channels to the sound reproduction positions based on the delays of the number of channels; and process the at least one audio signal with the reverberator based on the assigned channels to generate reverberated playback audio signals for the listening position.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows a model of room acoustics and the room impulse response;

FIG. 2 shows schematically an example apparatus within which some embodiments may be implemented;

FIG. 3 shows a flow diagram of the operation of the example apparatus as shown in FIG. 2;

FIG. 4 shows schematically an example reverberator as shown in FIG. 2 in further detail according to some embodiments;

FIG. 5 shows a flow diagram of the operation of the example reverberator as shown in FIG. 4;

FIG. 6 shows schematically an example reverberant signal router as shown in FIG. 2 in further detail according to some embodiments;

FIG. 7 shows a flow diagram of the operation of the example reverberant signal router as shown in FIG. 6;

FIGS. 8 to 11 shows an example reverberation to loudspeaker channel routing sequence;

FIG. 12 shows schematically an example binaural renderer as shown in FIG. 2 in further detail according to some embodiments;

FIG. 13 shows a flow diagram of the operation of the example binaural renderer as shown in FIG. 12;

FIG. 14 shows schematically an example feedback-delay-network (FDN) reverberator according to some embodiments;

FIG. 15 shows the implementation of the apparatus as shown in FIG. 2 within an example application according to some embodiments; and

FIG. 16 shows an example device suitable for implementing the apparatus shown in previous figures.

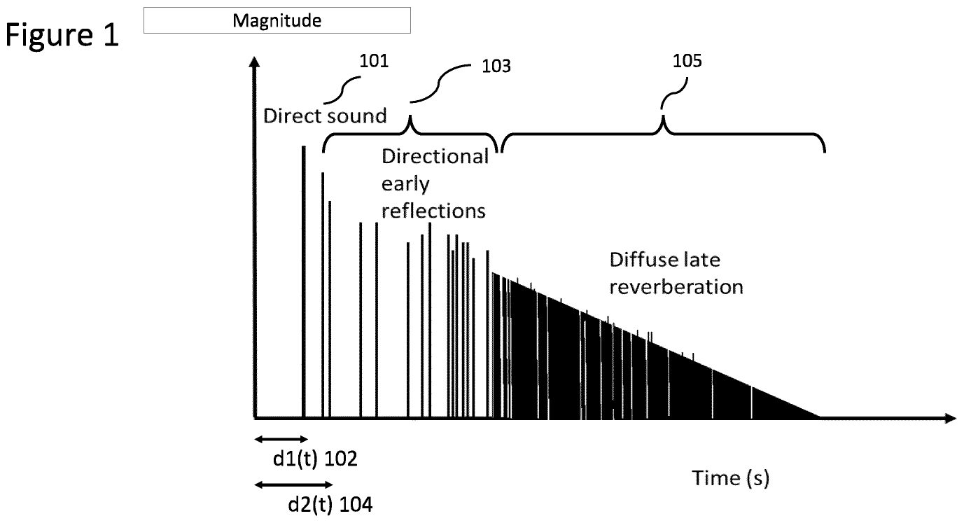

### EMBODIMENTS OF THE APPLICATION

The following describes in further detail suitable apparatus and possible mechanisms for parameterizing and rendering audio scenes with diffuse reverberation.

As discussed above reproducing reverberation from N incoherent loudspeakers (virtual or real) around the listener often reproduces the perception of diffuse reverberation. However, depending on the reverberator, it may not always produce a perception of fully surrounding and enveloping reverberation.

For example when using feedback delay network (FDN) reverberators, the spatial sound image may “collapse” into some directions or a single direction. This may be perceived as if the reverberation is mostly originating from some direction, such as left, or right, or front, or back, instead of being surrounding and enveloping.

The FDN reverberators comprise delay lines with different lengths for different output channels. In practice, in the beginning of the reverberation, the outputs for the different channels are relatively coherent before the density of the impulses is high enough. As a result, the timing of the first impulses affects the perceived direction of the reverberation. For example in the situation where the virtual loudspeakers on the left side of the listener get reverberated signals that have relatively earlier impulses than the other virtual loudspeakers, the sound image is perceived to collapse to the left side of the listener. As the late reverberation is aimed to be perceived as surrounding and enveloping, this is obviously not desired, and makes the perception of the reverberation unnatural.

Although it may be possible to use decaying uncorrelated noise sequences as finite impulse response (FIR) filters to create the reverberated channels, this could lead to an implementation having a very high computational complexity, as the FIR filters would be very long. For example the FIR filters could have more than 96000 taps per channel in situations where there is reverberation greater than 2 seconds.

The concept which is described further with respect to the following embodiments thus relates to reproduction of diffuse reverberation, where apparatus and methods are proposed that enable computationally efficient rendering of surrounding and enveloping diffuse reverberation. In some embodiments this is achieved by determining N surrounding spatial positions, determining a N-channel FDN reverberator, ordering the reverberator channels based on the delay-line lengths, assigning the ordered reverberator channels to the spatial positions in a manner that the reverberator channels with similar delay-line lengths are distributed (far) away from each other, reverberating the input audio signal with the reverberator (having N channels), and spatializing the reverberated audio signals, e.g., by filtering the reverberated audio signals with the associated directional filter pairs (such as HRTFs) for binaural (headphone reproduction) or by panning with vector-base amplitude panning (VBAP) for loudspeaker reproduction (or just reproducing each reverberated channel from the loudspeaker closest to the desired spatial position).

In such embodiments the computational efficiency is thus improved by utilizing computationally efficient reverberators, such as FDN reverberators, that have only a relatively small number of filter taps, in contrast to using, for example, decaying noise bursts that have a very large number of filter taps (and are thus computationally heavy).

Although the following examples describe the use of a FDN reverberator some embodiments can comprise another reverberator with different output channels having varying delays. For example, various digital reverberators other than FDN where there are delay lines with different delays from which output channels are obtained can benefit from implementing the embodiments as described herein without the need of significant inventive input.

The embodiments as described herein can achieve the perception of surrounding and enveloping reverberation by suitable spatial distribution of the reverberator channels based on the delay-line lengths. As the reverberator channels with similar delay-line lengths are reproduced from spatial positions far away from each other, the reverberation is not perceived to originate from any particular direction. Moreover, if the reverberator channels with the shortest delay-line lengths are positioned to spatial positions maximally to the sides, the wideness of the reverberation is maximized. As a result, a human listener perceives the reverberation reproduced using the present invention as surrounding and enveloping. In some embodiments, for example when head tracking is used, the reverberator channels can be positioned evenly on the left, right, front, and back directions to ensure that the wideness of reverberation is similar to all directions regardless of head rotation.

In some embodiments the apparatus and methods employ 15 virtual loudspeakers which can be (pseudo-) evenly distributed around a listener according to a suitable spatial distribution. Then in such embodiment, a 15-channel FDN reverberator is employed for producing the reverberated signals for the virtual loudspeakers. The channels of the FDN reverberator can in these embodiments be ordered based on the delay-line lengths from the shortest to the longest.

In some embodiments the FDN channel with the shortest delay-line length is assigned to a virtual loudspeaker that is the leftmost or the rightmost (it does not matter which one is selected). Then, the FDN channel with the second shortest delay-line length is assigned to a virtual loudspeaker that is the furthest away from the previously assigned virtual loudspeaker. This approach can then be repeated for all the remaining FDN channels: the channel with the next shortest delay-line length is assigned to a virtual loudspeaker (for which no FDN channel is not yet assigned) that is the furthest away from the last assigned FDN channel.

Then, the input audio signal (e.g., a mono audio signal) can, according to these embodiments, be reverberated with the FDN reverberator, and the resulting reverberated audio signals are routed to the corresponding virtual loudspeakers as determined above.

Finally, in some embodiments, the virtual loudspeaker signals are filtered with head-related transfer functions (HRTF) that correspond to the directions of the virtual loudspeaker. The resulting binaural audio signals are summed, and the summed binaural audio signals are provided as an output of the reverberator. In some other embodiments, the virtual loudspeaker signals are reproduced from a physical loudspeaker setup instead of HRTF filtering for headphones.

As a result, in practice, the FDN channels can be assigned in a way that the FDN channels with similar delay-line length get rendered with virtual loudspeakers roughly equally left and right. As a result, the sound image does not collapse to any direction. On the contrary, the sound image is perceived to be surrounding and enveloping. Moreover, as the FDN reverberators are computationally efficient, the apparatus and method as shown in the following embodiments is also computationally efficient.

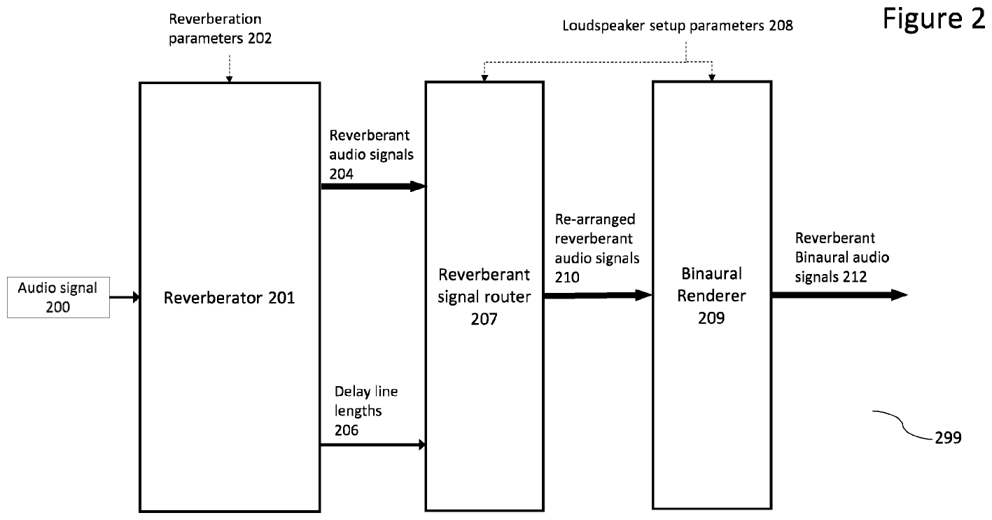

With respect to FIG. 2 is shown an example apparatus 299 embodiment. The input to the system is an audio signal 200 that is to be reverberated, the reverberation parameters 202 and the loudspeaker setup parameters 208. The apparatus 299 furthermore is configured to generate reverberant binaural audio signals 212 as an output, which are perceived as surrounding and enveloping.

The audio signal s(n) (where n is time) is forwarded to a reverberator 201. The reverberator 201 in some embodiments is implemented as a feedback delay network (FDN) reverberator with N channels. A FDN reverberator with N channels is configured to produce N (nearly) mutually incoherent reverberated signals as an output.

Furthermore in some embodiments the reverberator is configured to receive the reverberation parameters 202. The reverberation parameters 202 comprise parameters that control the generation of the reverberation (e.g., desired reverberation times RT60(f), reverberant-to-direct ratios RDR(f) (or other equivalent representation such as diffuse-to-total emitted energy ratio or diffuse-to-source energy ratio), and/or dimensions and/or one or more materials of a virtual environment). Thus, for example, the reverberation parameters 202 are used to configure the FDN reverberator 201. In some embodiments the input 202 to the reverberator 201 can be FDN reverberator parameters such as attenuation filter parameters, parameters for an RDR control filter, and so on.

In some embodiments the reverberator 201 is configured to produce reverberant audio signals sᵣₑᵥ(n, i) 204 (where i is the channel index) as an output. These are mutually incoherent reverberated signals. Furthermore the reverberator is configured to determine and output delay-line lengths ξ(n) 206, which correspond to the delays m₁ through m_{D} in the FDN reverberator.

The reverberant audio signals sᵣₑᵥ(n, i) 204 and the delay-line lengths ξ(i) 206 are forwarded to a reverberant signal router 207, which also receives the loudspeaker setup parameters θₗₛ(i), ϕₗₛ(i) 208 as an input.

The loudspeaker setup parameters comprise information which can be used for creating a perception of enveloping diffuse reverberation. Such information was discussed above. An illustrative example of loudspeaker setup parameter values are:
Azimuth θₗₛ(i): 0, 45, 90, 135, 180, −135, −90, −45, 45, 135, −135, −45, 45, 135, −135, −45 degrees.
Elevation ϕₗₛ(i): 0, 0, 0, 0, 0, 0, 0, 0, 30, 30, 30, 30, −30, −30, −30, −30 degrees.

There are therefore N channel positions defined by the loudspeaker setup parameters. In the example described above there are 16 channels, though N can be less than or more than 16 in other embodiments.

The apparatus 299 in some embodiments further comprises a reverberant signal router 207 which is configured to route the reverberant audio signals sᵣₑᵥ(n, i) 204 based on the delay-line lengths ξ(i) 206 so that when reproduced with a (real or virtual) loudspeaker setup, corresponding to the loudspeaker setup parameters 208, the reverberation is perceived as surrounding and enveloping. The reverberant signal 207 is thus in some embodiments configured to determine and output re-arranged reverberant audio signals sᵣₑᵥ₋ᵣₑₐᵣᵣ(n, i) 210.

The apparatus 299 in some embodiments can comprise a binaural renderer 209 (or more generally an output renderer) which is configured to receive the re-arranged reverberant audio signals sᵣₑᵥ₋ᵣₑₐᵣᵣ(n, i) 210 and the loudspeaker setup parameters 209. The binaural renderer 209 is further configured to render the reverberated audio signals to reverberant binaural signals s_{bin}(n, j) 212 (where j is the binaural channel), and which can, for example, be reproduced using headphones. These signals are perceived as surrounding and enveloping. As indicated above the binaural renderer 209 can be replaced by a suitable renderer (or spatializer) configured to generate a suitable number of channel outputs.

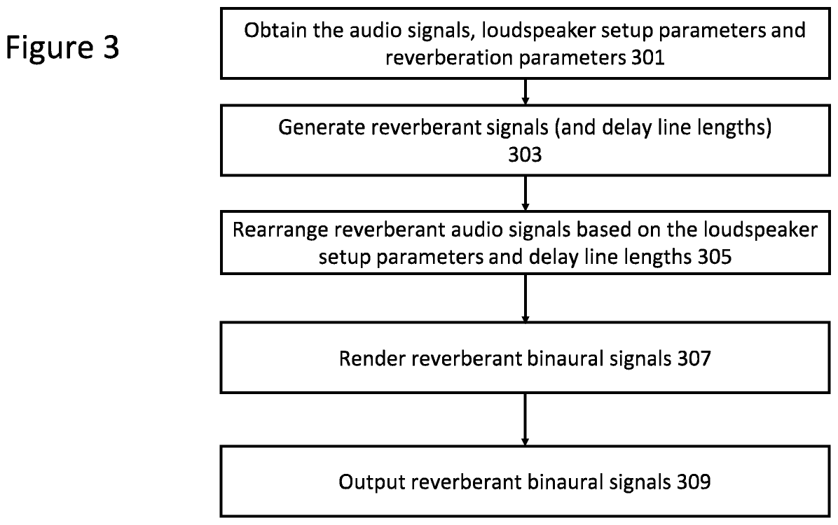

With respect to FIG. 3 is shown a flow diagram of the operations of the example apparatus 299 shown in FIG. 2.

In some embodiments the method comprises the operation of obtaining the audio signals, the loudspeaker setup parameters defining the (virtual) loudspeaker positions and the reverberation parameters for controlling the reverberation processing as shown in FIG. 3 by step 301.

Having obtained the audio signals and the reverberation parameters the method can then be configured to determine or generate reverberant audio signals based on the input audio signals and the reverberation parameters. Furthermore the method comprises determining associated reverberation delay line lengths. The operation of generating the reverberant audio signals and the delay line lengths is shown in FIG. 3 by step 303.

The method can then be configured to rearrange reverberant audio signals based on the loudspeaker setup parameters and the delay line lengths as shown in FIG. 3 by step 305.

Having rearranged the reverberant audio signals then the method can further comprise rendering suitable reverberant binaural signals based on the loudspeaker setup parameters as shown in FIG. 3 by step 307.

Furthermore the method may comprise outputting the reverberant binaural signals as shown in FIG. 3 by step 309.

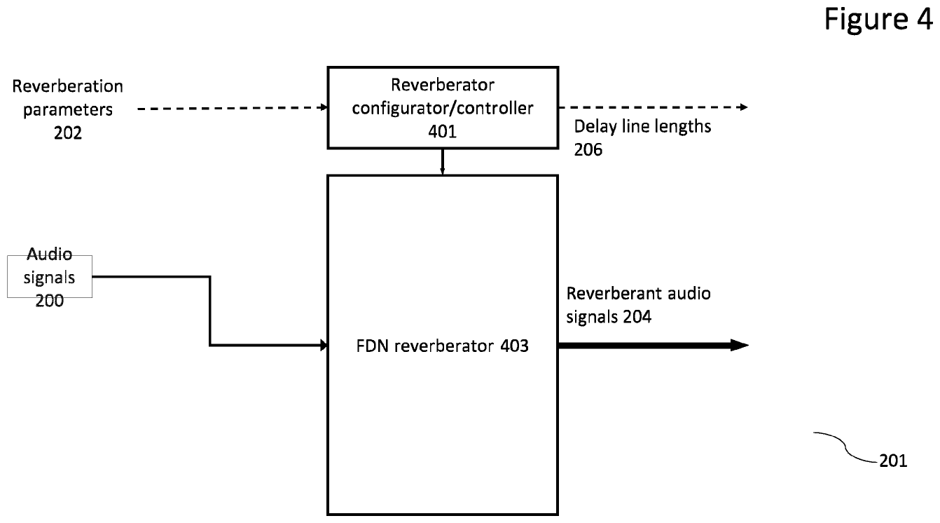

FIG. 4 shows schematically the reverberator 201 as shown in FIG. 2 in further detail. As described above in some embodiments the reverberator 201 comprises a feedback delay network (FDN) reverberator 403 and a reverberator configurator/controller 401.

In some embodiments the reverberator configurator/controller 401 is configured to obtain the reverberation parameters 202 and generate suitable configuration parameters to control the FDN reverberator 403. Additionally in some embodiments the reverberator configurator/controller 401 is configured to determine or otherwise obtain the delay line lengths 206. The delay line lengths 206 can furthermore be output from the reverberator 201.

The FDN reverberator 403, after being configured by the control parameters from the reverberator configurator/controller 401, can produce reverberant audio signals 204 having desired reverberation characteristics based on applying reverberation to the audio signals 200.

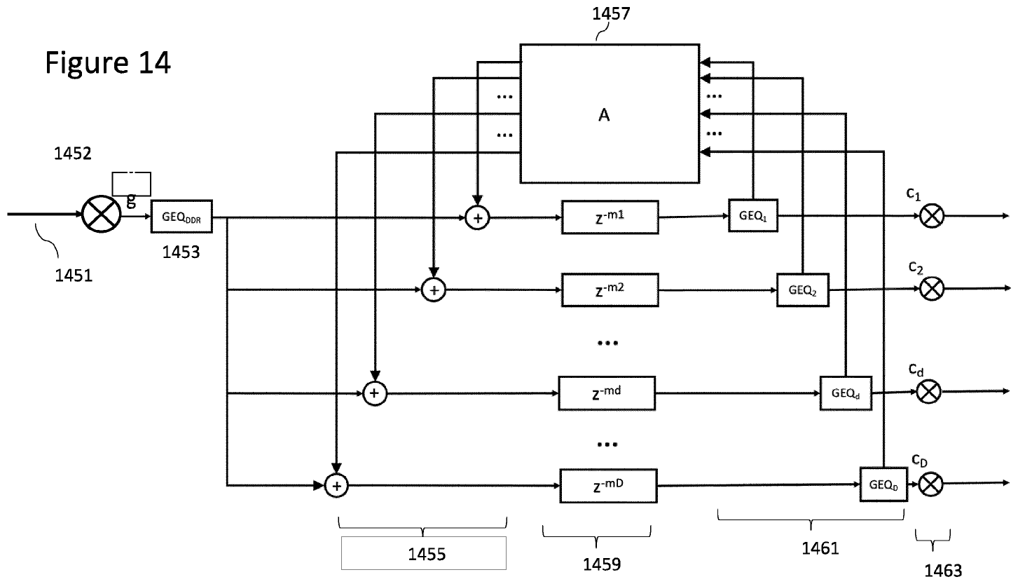

FIG. 14 shows an example FDN reverberator in further detail and which can be used to produce D uncorrelated output audio signals. In this example each output signal can be rendered at a certain spatial position around the listener for an enveloping reverb perception.

The FDN reverberator 403 in some embodiments comprises an input gain amplifier 1452 configured to receive the input 1451 and apply a gain g and output the gain applied input to a DDR energy ratio control filter (GEQ_{DDR}) 1453. The energy ratio control filter can also be referred as reverberant-to-direct ratio (RDR) control filter. The goal of the filter is to produce a desired reverberation level (energy) when given a unit energy input.

The example FDN reverberator 403 further comprises a DDR energy ratio control filter (GEQ_{DDR}) 1453 which applies a filter configured by the DDR energy ratio control filter coefficients GEQ_{ddr}. Furthermore the reverberator is configured such that the reverberation parameters are processed to generate coefficients GEQ_{d} (GEQ₁, GEQ₂, . . . GEQ_{D}) of each attenuation filter 1461, feedback matrix 1457 coefficients A, lengths m_{d} (m₁, m₂, . . . m_{D}) for D delay lines 1459. Delay lines 1459 are sometimes referred as feedback loops. The lengths are sometimes referred as loop filter delays. The example FDN reverberator 403 thus shows a D-channel output, by providing the output from each FDN delay line as a separate output.

In some embodiments each attenuation filter GEQ_{d} 1461 is implemented as a graphic EQ filter using M biquad IIR band filters. With octave bands M=10, thus, the parameters of each graphic EQ comprise the feedforward and feedback coefficients for biquad IIR filters, the gains for biquad band filters, and the overall gain.

The reverberator uses a network of delays 1459, feedback elements (shown as attenuation filters 1461, feedback matrix 1457 and combiners 1455 and output gain 1463).

The FDN reverberator comprises multiple recirculating delay lines. The unitary matrix A 1457 is used to control the recirculation in the network. Attenuation filters 1461 which may be implemented in some embodiments as graphic EQ filters implemented as cascades of second-order-section IIR filters can facilitate controlling the energy decay rate at different frequencies. The filters 1461 are designed such that they attenuate the desired amount in decibels at each pulse pass through the delay line and such that the desired RT60 time is obtained.

For the FDN reverberator 403 the parameters contain the coefficients of each attenuation filter GEQ_{d} 1461, feedback matrix coefficients A 1457, and lengths m_{d} for D delay lines 1459. In some embodiments, each attenuation filter GEQ_{d} 1461 is a graphic EQ filter using M biquad IIR band filters.

With octave bands M=10, thus, the parameters of each graphic EQ comprise the feedforward b and feedback a coefficients for 10 biquad IIR filters, the gains for biquad band filters, and the overall gain.

The number of delay lines D can be adjusted depending on quality requirements and the desired tradeoff between reverberation quality and computational complexity. In an embodiment, an efficient implementation with D=15 delay lines is used. This makes it possible to define the feedback matrix coefficients A as proposed by Rocchesso in Maximally Diffusive Yet Efficient Feedback Delay Networks for Artificial Reverberation, IEEE Signal Processing Letters, Vol. 4. No. 9, September 1997, in terms of a Galois sequence facilitating efficient implementation.

A length m_{d} for the delay line d can be determined based on virtual room dimensions. Here, we use the dimensions of the enclosure. For example, a shoebox shaped room can be defined with dimensions xDim, yDim, zDim. If the room is not shaped as a shoebox (or cuboid) then a shoebox can be fit inside the room and the dimensions of the fitted shoebox can be utilized for the delay line lengths. Alternatively, the dimensions can be obtained as three longest dimensions in the non-shoebox shaped room, or other suitable method. Such dimensions can also be obtained from a mesh if the bounding box is provided as a mesh. The dimensions can further be converted to modified dimensions of a virtual room or enclosure having the same volume as the input room or enclosure. For example, the ratios 1, 1.3, and 1.9 can be used for the converted virtual room dimensions. When the method is executed in the renderer then the enclosure vertices are obtained from the bitstream and the dimensions can be calculated, along each of the axes x, y, z, by the difference of the maximum and minimum value of the vertices.

The delays can in some embodiments be set proportionally to standing wave resonance frequencies in the virtual room or physical room. The delays can thus be set proportionally to standing wave resonance frequencies in the virtual room or physical room (the acoustic environment).

Room modes can be defined as

```
roomModes{
  { 1, 0, 0 },
  { 0, 2, 1 },
  { 1, 0, 1 },
  { 2, 1, 0 },
  { 0, 1, 1 },
  { 1, 1, 1 },
  { 1, 1, 0 },
  { 0, 1, 2 },
  { 1, 2, 1 },
  { 1, 2, 0 },
  { 0, 0, 1 },
  { 2, 1, 1 },
  { 0, 1, 0 },
  { 1, 0, 2 },
  { 2, 0, 1 },
  };
```

The calculation of the ith delay can be as follows:

$$\begin{matrix}xMode = roomModes [ i ] [ 0 ] / xDim ; \\ yMode = roomModes [ i ] [ 1 ] / yDim ; \\ zMode = roomModes [ i ] [ 2 ] / zDim ; \\ xMod {e}^{⋆} = x M ode ; \\ {yMode}^{*} = yMode ; \\ zMod {e}^{⋆} = z M ode ;\end{matrix}$$

$$reso n a n c e Freq = 0.5 * 343 * sqrt ( xMode + yMode + zMode ) ;$$

$$delays [ i ] = sampleRateHz / resonanceFreq ;$$

The delays can be sorted into ascending order.

The delay line lengths m_{d} can further be made mutually prime integers. This choice maximizes the number of samples in the FDN output impulse response before it repeats. The sieve of the Sundaram algorithm can be used to find the prime numbers up to the maximum delay line length. Each delay line length can then be mapped to the closest prime number in the obtained set of prime numbers.

The attenuation filter coefficients in the delay lines can furthermore be adjusted so that a desired amount in decibels of attenuation happens at each signal recirculation through the delay line so that the desired RT60(k) time is obtained. This is done in a frequency specific manner to ensure the appropriate rate of decay of signal energy at specified frequencies k.

For a frequency k, the desired attenuation per signal sample is calculated as attenuationPerSample(k)=−60/(samplingRate*RT60(k)). The attenuation in decibels for a delay line of length m_{d} is then attenuationDb(k)=m_{d}* attenuationPerSample(k).

Furthermore the attenuation filters are designed as cascade graphic equalizer filters as described in V. Välimäki and J. Liski, “Accurate cascade graphic equalizer,” IEEE Signal Process. Lett., vol. 24, no. 2, pp. 176-180, February 2017, for each delay line. The design procedure outlined takes as input a set of command gains at octave bands. There are also methods for a similar graphic EQ structure which can support third octave bands, increasing the number of biquad filters to 31 and providing better match for detailed target responses such as indicated in Third-Octave and Bark Graphic-Equalizer Design with Symmetric Band Filters, https://www.mdpi.com/2076-3417/10/4/1222/pdf.

Reverberation ratio parameters can refer to the diffuse-to-total energy ratio (DDR) or reverberant-to-direct ratio (RDR) or other equivalent representation. The ratio parameters can be equivalently represented on a linear scale or logarithmic scale.

A filter is designed in the step such that, when the filter is applied to the input data of the FDN reverberator, the output reverberation is configured to have the desired energy ratio defined by the DDR(k). The input to the design procedure can in some embodiments be the DDR values DDR(k). When the input values are provided at arbitrary frequencies k, the values can be converted via interpolation to desired frequency band center frequencies b, such as octave band center frequencies.

When receiving linear DDR values DDR(b), the values can be converted to linear RDR values as

$$R D R ( b ) = DDR ( b ) * {10}^{( 41 / 10 )}$$

When receiving logarithmic RDR values logRDR(b), the values can be converted to linear RDR values as

$$R D R ( b ) = 1 {0}^{( l o g R D R ( b ) / 10 )}$$

The GEQ_{DDR} matches the reverberator spectrum energy to the target spectrum energy. In order to do this, an estimate of the RDR of the reverberator output and the target RDR is obtained. The RDR of the reverberator output can be obtained by rendering a unit impulse through the reverberator using the first reverberator parameters and measuring the energy of the reverberator output and energy of the unit impulse and calculating the ratio of these energies.

In some embodiments a unity impulse input is generated where the first sample value is 1 and the length of the zero tail is long enough. In practice, we have adjusted the length of the zero tail to equal max(RT60(b)) plus the t_{predelay} in samples, where t_{predelay} is the predelay time in seconds. The monophonic output of the reverberator is of interest so the filter is configured to sum over the delay lines j to obtain the reverberator output sᵣₑᵥ(t) as a function of time t.

A long FFT (of length NFFT) is calculated over sᵣₑᵥ(t) and its absolute value is obtained as

FFA(kk)=abs(FFT(sᵣₑᵥ(t))

Here, kk are the FFT bin indices. The positive half spectral energy density is obtained as

$$S ( k k ) = 1 / NFFT * {FFA ( k k )}^{2}$$

where the energy from the negative frequency indices kk is added into the corresponding positive frequency indices kk.

The energy of a unit impulse can be calculated or obtained analytically and can be denoted as Su(kk).

Band energies are calculated of both the positive half spectral energy density of the reverberator S(kk) and the positive half spectral energy density of the unit impulse Su(kk). Band energies can be calculated as

$$S ( b ) = {\sum }_{k k = {b}_{l o w}}^{{b}_{high}} S ( k k )$$

where b_{low} and b_{high} are the lowest and highest bin index belonging to band b, respectively. The band bin indices can be obtained by comparing the frequencies of the bins to the lower and upper frequencies of each band.

The reproduced RDRᵣₑᵥ(b) of the reverberator output at the frequency band b is obtained as

$$R D {R}_{r e v} ( b ) = S ( b ) / Su ( b )$$

The target linear magnitude response for GEQ_{DDR} can be obtained as

$$d d r F i l t e r T a r g etResponse ( b ) = s q r t ( R D R ( b ) ) / sqr t ( R D {R}_{r e v} ( b ) )$$

where RDR(b) is the linear target RDR value mapped to frequency band b.

GontrolGain(b)=20*log10(ddrFilterTargetResponse(b)) is input as the target response for the graphic equalizer design routine in Välimäki, Rämö, “Neurally Controlled Graphic Equalizer”, IEEE/ACM TRANSACTIONS ON AUDIO, SPEECH, AND LANGUAGE PROCESSING, VOL. 27, NO. 12, December 2019 or other suitable routine (the control gains).

The DDR filter target response (control gains for the graphic EQ design routine) can also be obtained directly in the logarithmic domain as

$$ControlGain ( b ) = 10 {log}_{10} ( R D R ( k ) ) - 10 {log}_{10} ( R D {R}_{r e v} ( b ) )$$

The audio processing in the for each audio block of length B audio input samples in the reverberator can involve the following steps, as described in m59696 “First version of Text of Working Draft of RM0”:

Writing B input samples into the predelay line (if one exists). In FIG. 14 no predelay line is depicted, but to implement a desired predelay for the FDN reverberator an additional predelay line can be implemented. The length of the additional predelay line can in embodiments be equal to the desired predelay (in samples) subtracted by the length of the shortest FDN delay line (in samples).

Reading B predelayed input samples from the predelay line.

The predelayed input samples can further be filtered with the RDR control filter to obtain ratio-controlled input samples to the FDN reverberator. The RDR control filters GEQ_{RDR} and the delay line attenuation filters can in some embodiments be cascades of second order section filters implementing a GEQ filterbank. Such a second order section filter can be implemented with the following procedure. The input sample is at sample, and the output is filteredSample.

```
filterSOSCascade(filterParameters, sample) {
  a1, a2, b1, b2, wPast0, wPast1, levelAndFFactor =
filterParameters;
  filteredSample = sample;
  for (i = 0; i < numBands; i++) {
    filteredSample = filterSOS(
      filteredSample, a1[i], a2[i], b1[i], b2[i], wPast0[i],
wPast1[i]);
  }
  filteredSample = levelAndFFactor * filteredSample;
}
```

Where numBands is the number of band filters in the SOS cascade.
levelAndFactor can be calculated as levelAndFactor=G₀*db2mag(−levelDb). levelDb is an offset in decibels subtracted from the target response of the GEQ filterbank before design. This makes the GEQ design easier in some embodiments as the GEQ does not need to model the average gain of the response but it is handled separately. G₀ is the global gain for the GEQ filterbank.
The coefficients a1[i], a2[i], b1[i], b2[i] are the feedback and feedforward coefficients of the ith IIR filter in the SOS cascade. The past output values wPast0 and wPast1 can be initialized to vectors of zeroes of length numBands and stored between sequential calls of the filterSOSCascade and filterSOS methods so that the filter state is preserved.
The procedure sosFilt can be used to implement a SOS filter in direct form 2 as follows:

```
float sosFilt(float sample, float a1, float a2, float b1, float b2,
  float& wPast0, float& wPast1)
{
  w = sample − a1 * wPast0 − a2 * wPast1;
  sample = w + b1 * wPast0 + b2 * wPast1;
  wPast1 = wPast0;
  wPast0 = w;
  return sample;
}
```

The FDN reverberator can process the ratio-controlled input samples at m_inputBuffer to produce NUM_OUTPUTS reverberated output signals sᵣₑᵥ(n, i) where i is the output channel index. The following code shows an example implementation:

```
outputBuffer = array(0.0f, OUTPUT_COUNT);
for (n = 0; n < sampleCount; n++) {
  d = 0.0f;
  for (i = 0; i < OUTPUT_COUNT; i++) {
    d += v[i];
  }
  alphaTimesD = alpha * d;
  updated_v = array(0.0f, OUTPUT_COUNT);
  for (delayLineIndex = 0; delayLineIndex < OUTPUT_COUNT;
delayLineIndex++) {
    s = &m_v[OUTPUT_COUNT − delayLineIndex];
    b = s[1] + s[2] + s[3] + s[5] + s[6] + s[9] + s[11];
    c = s[0] + s[4] + s[7] + s[8] + s[10] + s[12] + s[13] + s[14];
    a = 0.25F * (b − c) + alphaTimesD;
    delayedSample =
      getDelayedSample(m_delayLines[delayLineIndex],
m_inputBuffer[n] + a);
    filteredSample = filterSOSCascade(m_filters[delayLineIndex],
delayedSample);
    updated_v[delayLineIndex] = filteredSample;
    m_outputBuffer[delayLineIndex][n] += filteredSample;
  }
  copy_n(&updated_v[0], OUTPUT_COUNT, &m_v[0]);
  copy_n(&updated_v[0], OUTPUT_COUNT,
  &m_v[OUTPUT_COUNT]);
  outputScaler = 1.0f / OUTPUT_COUNT;
  for (outputChannelIndex = 0; outputChannelIndex <
OUTPUT_COUNT; outputChannelIndex++) {
    m_outputBuffer[j][n] *= outputScaler;
  }
}
```

In the above code example, copy_n(sourcePointer, count, targetPointer) copies count samples starting from a memory address pointed by sourcePointer to a memory address pointed by targetPointer.
array(value, count) initializes an array of length count with values value.
The operator &variable returns the memory address of variable.
The operator *pointer returns the value of the variable located at the address specified by pointer.
The operator variable++ increments the value of variable by one.
The output signal is thus at m_outputBuffer[j][n]. These correspond to the reverberated output signals sᵣₑᵥ(n, i) (the index j in the pseudo code corresponds to the index i in the equation).

The resulting reverberant audio signals sᵣₑᵥ(n, i) (where i is the output audio channel index) are the output of the reverberator 201. The reverberator furthermore also outputs the delay line lengths m1 through mD used for configuring the FDN reverberator.

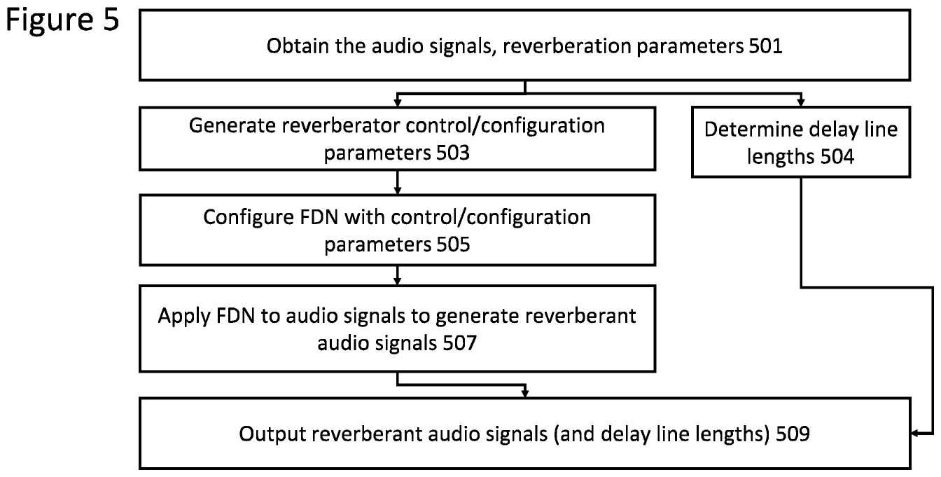

With respect to FIG. 5 is shown a flow diagram of the operations of the example reverberator as shown in FIG. 4. For example in some embodiments the method comprises obtaining the audio signals and the reverberation parameters as shown in FIG. 5 by step 501.

The method can then comprise generating reverberator control/configuration parameters as shown in FIG. 5 by step 503.

Additionally the method can comprise determining delay line lengths as shown in FIG. 5 by step 504.

Furthermore in some embodiments the method comprises configuring the FDN reverberator with the determined control/configuration parameters as shown in FIG. 5 by step 505.

Then having configured the FDN reverberator then apply the FDN reverberator to the audio signals to generate reverberant audio signals as shown in FIG. 5 by step 507.

Finally then the reverberant audio signals and delay line lengths can be output as shown in FIG. 5 by step 509.

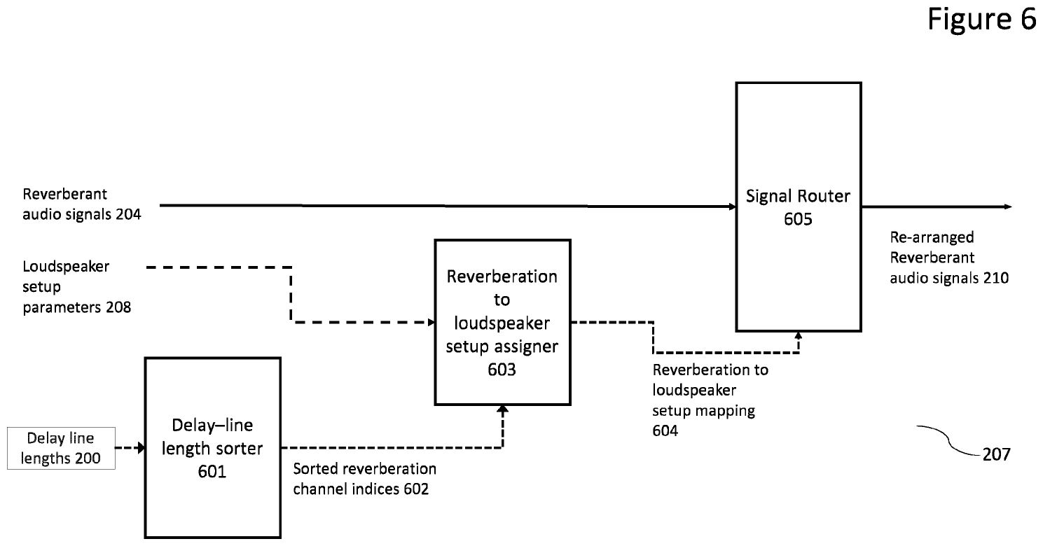

FIG. 6 shows a schematic view of the reverberant signal router 207 in further detail according to some embodiments. The delay line lengths ξ(i) 206 are forwarded to a delay-line length sorter 601 which is configured to arrange the delay-line lengths from the shortest to the longest. As a result, the indices of the reverberator channels following the sorted delay-line lengths are outputted as the sorted reverb channel indices ζ(i) 602.

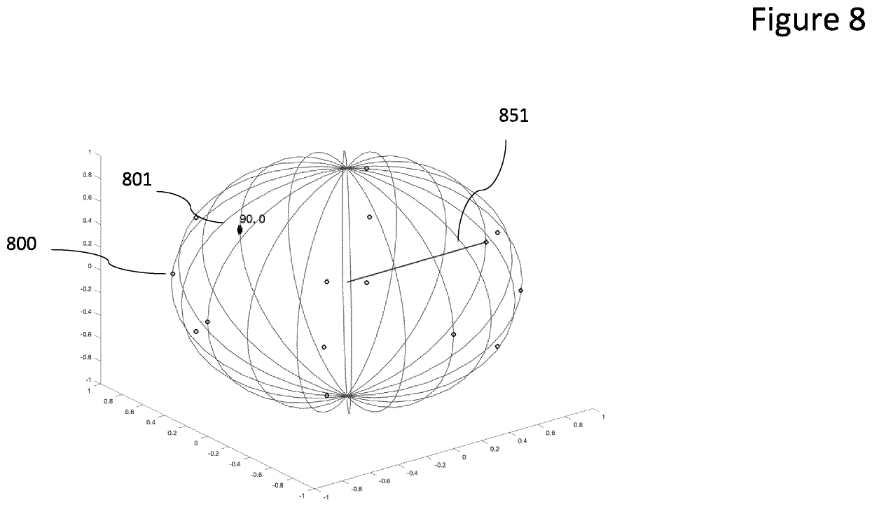

The reverberant signal router 207, in some embodiments, comprises a reverberation to loudspeaker set assigner 603. The reverberation to loudspeaker set assigner 603 is configured to receive the sorted reverb channel indices ζ(i) 602 and the loudspeaker setup parameters θₗₛ(i), ϕₗₛ(i) 208, which is configured to determine which reverberation channel should be reproduced from which (real or virtual) loudspeaker. The reverberation to loudspeaker setup assigner in some embodiments is configured to select the initial loudspeaker position from the left or right. In this example the reverberation to loudspeaker set assigner 603 is configured to select the loudspeaker closest to the left, located at azimuth 90, elevation 0 degrees. This selection is shown in FIG. 8 where the initial selection 801 is shown. The reverberation to loudspeaker setup assigner 603 can then create or otherwise start to generate a reverberation to loudspeaker setup mapping μ(i) 604 which contains the mapping from sorted reverb channel indices ζ(i) to loudspeaker setup parameters θₗₛ(i), ϕₗₛ(i). For example, the mapping μ(i) can contain the assigned sorted reverberation channel index for each loudspeaker θₗₛ(i), ϕₗₛ(i). In this example μ(3)=1. In FIG. 8 the black circles, for example 800, correspond to loudspeaker positions and black star 801 with the azimuth, elevation denoted next to it denotes an assignment of reverb channel to a loudspeaker. The vector 851 denotes the front direction (azimuth of zero degrees, elevation of zero degrees).

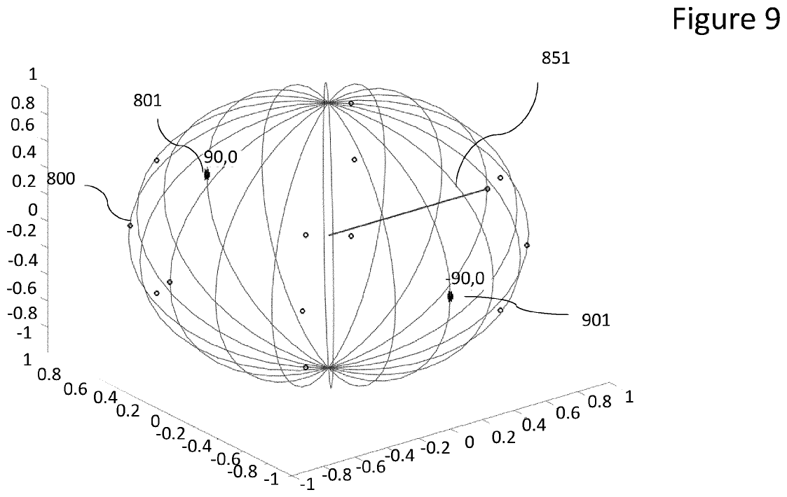

The reverberation to loudspeaker setup assigner 603 can then be configured to calculate the distances from the initial loudspeaker position to remaining loudspeaker positions. The distance can be calculated in the cartesian coordinate domain. The azimuth and elevation angles (with a set radius value of unity) of the loudspeaker setup can be converted to cartesian coordinates, and the Euclidean distance between the initial loudspeaker position and remaining loudspeaker positions can be calculated. The reverberation to loudspeaker setup assigner 603 can then be configured to select the next loudspeaker as the one having the longest (or furthest) distance from the initial loudspeaker position. The next selection is at distance 2 the loudspeaker position at azimuth −90 elevation 0 as shown in FIG. 9 by the star 901. In some embodiments the distances between loudspeaker positions can be calculated in the beginning of the procedure and stored into a data structure such as a distance matrix having the loudspeaker positions at rows and columns and entries corresponding to the distance and during iterations the distance values can be obtained from the distance matrix (instead of calculating them).

The assignment is μ(7)=2.

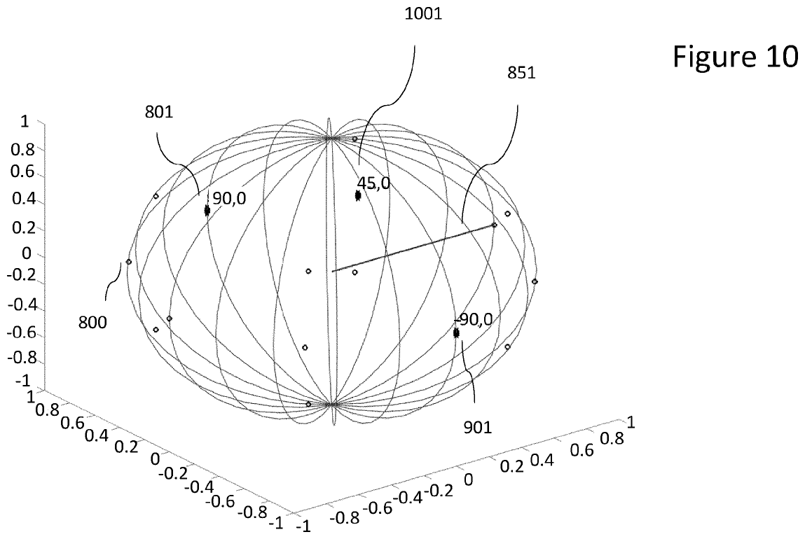

This procedure is then continued until all reverberation channels are assigned to loudspeaker positions. At each iteration, the distance from the loudspeaker position just selected is calculated to remaining loudspeaker positions and the new position is selected as the one maximizing the distance. For example FIG. 10 depicts the third step of the assignment when the next loudspeaker position 1001 is selected and the mapping extended, μ(2)=4.

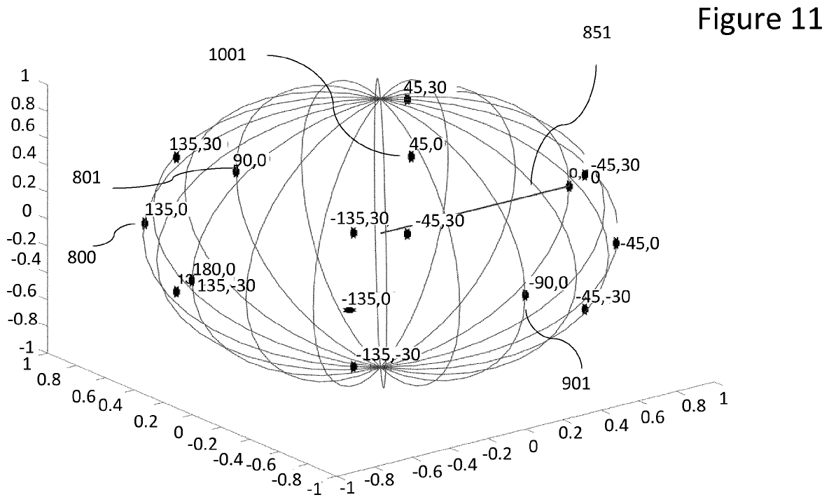

All 16 reverberation channels have been assigned after the procedure completes and the results are shown in FIG. 11.

The resulting assignments are μ(i), i=1, . . . , 16: 7, 3, 1, 10, 8, 4, 2, 9, 5, 14, 16, 11, 15, 12, 6, 13

In the assignments, a value at μ(i)=j means that sorted reverb output at index j is routed to the loudspeaker at index i. That is, the reverb output corresponding to the shortest delay line (at the index 1) is routed to the loudspeaker at index 3 (90, 0). The next shortest delay line (at the index 2) is routed to the loudspeaker at index 7 (−90, 0) and so on.

In some embodiments where there are more reverberator outputs than loudspeaker channels, the method can start again from the beginning after all loudspeaker channels have a reverberator output assigned. This means that some loudspeaker channels can have more than one reverberator channel as an input and the reverberator channels can be summed into the loudspeaker channel.

In some embodiments where there are fewer reverberator outputs than loudspeaker channels the method stops after all reverberator output channels have been assigned. This means that not all loudspeaker channels may have a reverberator output channel assigned and will thus not render reverberated signals.

Alternatively, in some embodiments, additional decorrelation can be applied to some of the reverberator output channels to create additional reverberation channels for (some) of the remaining loudspeakers if that is beneficial in some scenarios such as not having sufficient number of loudspeakers reproducing reverberation signals.

The resulting reverberation to loudspeaker setup mapping μ(i) is forwarded to a signal router 605 alongside the reverberant audio signals sᵣₑᵥ(n, i) 204. Then by employing the mapping, the signal router 605 is configured to determine re-arranged reverberant audio signals 210, for example using the following:

$${s}_{r e v - r e a r r} ( n , i ) = {s}_{r e v} ( n , μ ( i ) )$$

The re-arranged reverberant audio signals sᵣₑᵥ₋ᵣₑₐᵣᵣ(n, i) 210 can then be output.

It is noted that in some embodiments the rearranged reverberation signals are not implemented as a separate module after the reverberator. An example is an implementation where the reverberant audio signals output from the FDN reverberator are arranged in the order of shortest delay line to the longest delay line (by arranging the delay lines in the FDN accordingly), and then the reverberated output signals are provided spatial positions matching the reverberation to loudspeaker set assigner 603. Such reverberated output signals with the spatial position can then be rendered from the corresponding spatial position with HRTF filtering or from a loudspeaker.

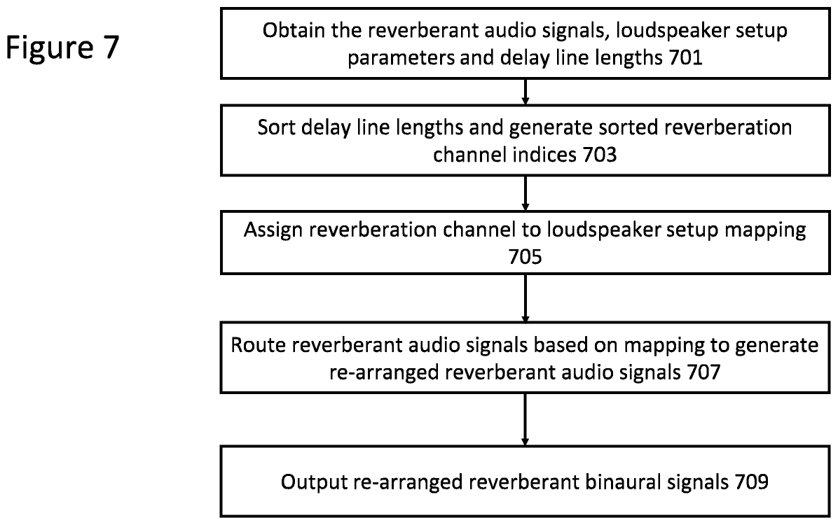

With respect to FIG. 7 there is shown a flow diagram of the operations of the reverberant signal router 207 is shown. The method may comprise the operation of obtaining the reverberant audio signals, loudspeaker setup parameters and delay line lengths as shown in FIG. 7 by step 701.

The method can then furthermore comprise sorting delay line lengths and generating sorted reverberation channel indices as shown in FIG. 7 by step 703.

The next operation can comprise assigning or generating reverberation channel to loudspeaker setup mapping as shown in FIG. 7 by step 705.

Then the method can comprise routing reverberant audio signals based on mapping to generate re-arranged reverberant audio signals as shown in FIG. 7 by step 707.

Furthermore the method comprises outputting re-arranged reverberant signals as shown in FIG. 7 by step 709.

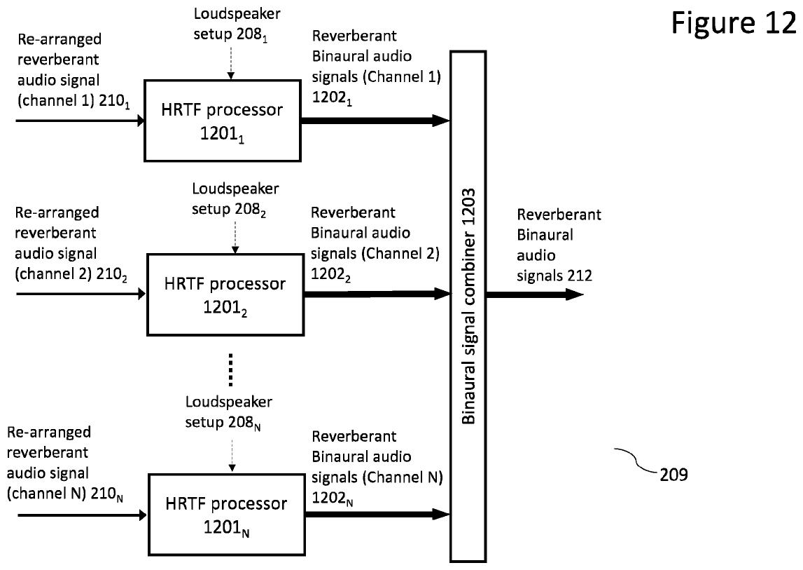

FIG. 12 furthermore shows schematically the binaural renderer 209 as shown in FIG. 2 in further detail.

The input to the binaural renderer 209 is the re-arranged reverberant audio signals sᵣₑᵥ₋ᵣₑₐᵣᵣ(n, i) 210 and the loudspeaker setup parameters θₗₛ(i), ϕₗₛ(i) 208. In the example shown in FIG. 12 the binaural renderer 209 is organized on a channel-by-channel basis and in the example shown in FIG. 12 there a number of HRTF processors (one per channel) 1201. For example for a first channel a HRTF processor 1201₁ configured to receive the re-arranged reverberant audio signal (channel 1) 210₁ and the loudspeaker setup associated with channel 1 208₁. For a second channel a HRTF processor 1201₂ configured to receive the re-arranged reverberant audio signal (channel 2) 210₂ and the loudspeaker setup associated with channel 2 208₂. Also is shown a N'th channel HRTF processor 1201_{N} configured to receive the re-arranged reverberant audio signal (channel N) 210_{N} and the loudspeaker setup associated with channel N 208_{N}. Each of the HRTF processors can comprise an HRTF filter pair h_{bin}(m, j, i) (where m is the time index of the filter coefficients and j is the index of the binaural channels) is selected for each loudspeaker channel i.

Using the HRTF filter pairs h_{bin}(m, j, i), reverberant binaural audio signals s_{bin}(n, j, i) 1202 can be determined for each channel of the re-arranged reverberant audio signals 210 by

$${s}_{b i n} ( n , j , i ) = {h}_{b i n} ( m , j , i ) ⊗ {s}_{r e v - r e a r r} ( n , i )$$

where ⊗ denotes convolution (the filtering may also be performed in the frequency domain in some implementations instead of time-domain convolution). The reverberant binaural audio signals s_{bin}(n, j, i) 1202 can then be passed to a binaural signal combiner 1203.

The reverberant binaural audio signals s_{bin}(n, j, i) 1202 can the be combined for the different loudspeaker channels i in the binaural signal combiner 1203 by

$${s}_{b i n} ( n , j ) = {\sum }_{i} {s}_{b i n} ( n , j , i )$$

yielding the reverberant binaural signals s_{bin}(n, j) 212 which is the output.

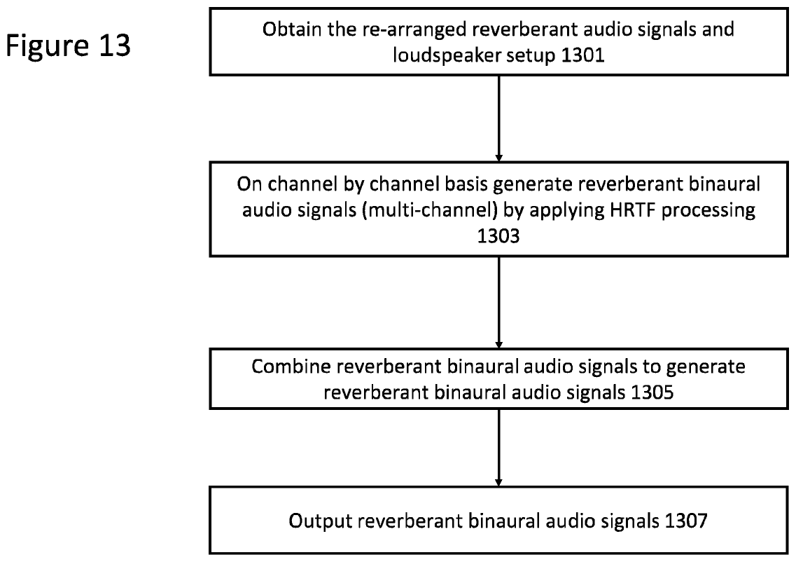

The operations of the binaural renderer is shown in the flow diagram from FIG. 13.

The first operation is obtaining the re-arranged reverberant audio signals and loudspeaker setup as shown in FIG. 13 step 1301.

Then the method can comprise on a channel-by-channel basis generating reverberant binaural audio signals (multi-channel) by applying HRTF processing as shown in FIG. 13 by step 1303.

The method may then comprise combining reverberant binaural audio signals to generate reverberant binaural audio signals as shown in FIG. 13 by step 1305.

Then the reverberant binaural audio signals can be output as shown in FIG. 13 by step 1307.

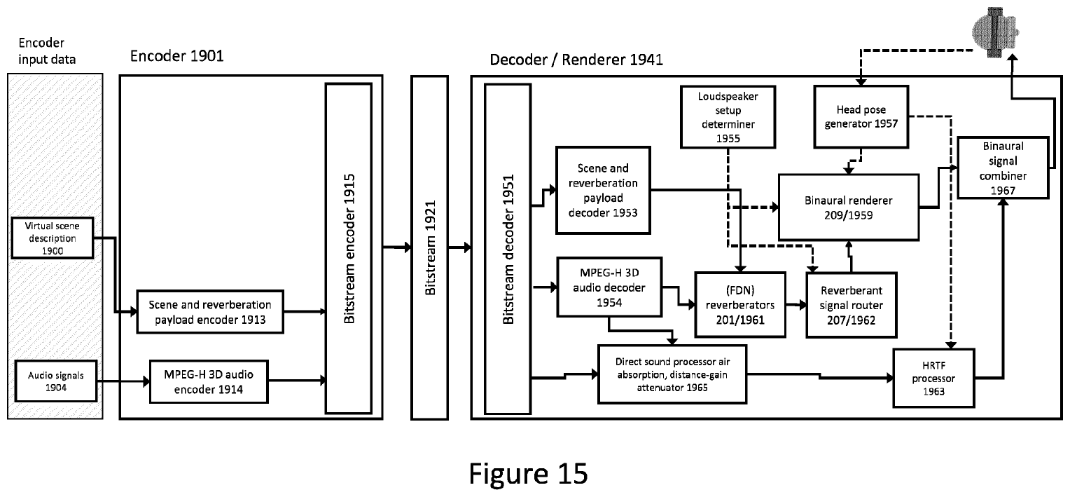

FIG. 15 shows schematically an example system where the embodiments are implemented in an encoder device 1901 which performs part of the functionality; writes data into a bitstream 1921 and transmits that for a renderer device 1941, which decodes the bitstream, performs reverberator processing according to the embodiments and outputs audio for headphone listening.

The encoder side 1901 of FIG. 15 can be performed on content creator computers and/or network server computers. The output of the encoder is the bitstream 1921 which is made available for downloading or streaming. The decoder/renderer 1941 functionality runs on end-user-device, which can be a mobile device, personal computer, sound bar, tablet computer, car media system, home HiFi or theatre system, head mounted display for AR or VR, smart watch, or any suitable system for audio consumption.

The encoder 1901 is configured to receive the virtual scene description 1900 and the audio signals 1904. The virtual scene description 1900 can be provided in the MPEG-I Encoder Input Format (EIF) or in other suitable format. Generally, the virtual scene description contains an acoustically relevant description of the contents of the virtual scene, and contains, for example, the scene geometry as a mesh, acoustic materials, acoustic environments with reverberation parameters, positions of sound sources, and other audio element related parameters such as whether reverberation is to be rendered for an audio element or not. The encoder 1901 in some embodiments comprises a scene and reverberation payload encoder 1913 configured to generate reverberation parameters.

The encoder 1901 further comprises a MPEG-H 3D audio encoder 1914 configured to obtain the audio signals 1904 and MPEG-H encode them and pass them to a bitstream encoder 1915.

The encoder 1901 furthermore in some embodiments comprises a bitstream encoder 1915 which is configured to receive the output of the scene and reverberation payload encoder 1913 and the encoded audio signals from the MPEG-H encoder 1914 and generate the bitstream 1921 which can be passed to the bitstream decoder 1941. The bitstream 1921 in some embodiments can be streamed to end-user devices or made available for download or stored.

The decoder 1941 in some embodiments comprises a bitstream decoder 1951 configured to decode the bitstream.

The decoder 1941 further can comprise a scene and reverberation payload decoder 1953 configured to obtain the encoded reverberation parameters and decode these in an opposite or inverse operation to the reverberation payload encoder 1913.

The loudspeaker setup determiner 1955 is configured to generate and pass the loudspeaker configuration parameters to the reverberant signal router 207/1962 and the binaural renderer 209/1959.

Furthermore the head pose generator 1957 receives information from a head mounted device or similar and generates head pose information or parameters which can be passed to the binaural renderer 209/1959 and HRTF processor 1963.

The decoder 1941 comprise MPEG-H 3D audio decoder 1954 which is configured to decode the audio signals and pass them to the (FDN) reverberators 1961 and direct sound processing 1965.

The decoder 1941 furthermore comprises (FDN) reverberators 1961 configured to implement a suitable reverberation of the audio signals.

The output of the (FDN) reverberators 1961 is configured to output to a reverberant signal router 207/1962.

In some embodiments the decoder 1941 comprises a reverberant signal router 207/1962 configured to apply signal routing as described above.

The decoder further comprises a binaural renderer 209/1959 configured to generate binaural reverberant audio signals.

Additionally the decoder/renderer 1941 comprises a direct sound processor 1965 which is configured to receive the decoded audio signals and configured to implement any direct sound processing such as air absorption and distance-gain attenuation and which can be passed to a HRTF processor 1963 which with the head orientation determination (from a suitable sensor) can generate the direct sound component which with the reverberant component from the HRTF processor 1963 is passed to a binaural signal combiner 1967. The binaural signal combiner 1967 is configured to combine the direct and reverberant parts to generate a suitable output (for example for headphone reproduction).

Furthermore in some embodiments the decoder comprises a head orientation determiner which passes the head orientation information to the head pose generator 1957.

Although in FIG. 15 it is depicted that the reverberator output assignment happens in the renderer device it can also happen in the encoder device. For example, the encoder device can calculate the suitable positions for the reverberator outputs and then signal them in the bitstream for different loudspeaker configurations. Also, as an alternative to transmitting reverberation parameters from the encoder to the renderer it is possible in some embodiments to transmit reverberator parameters in the bitstream. Reverberator parameters refer to the FDN parameters such as delay line lengths, attenuation filters, reverberation ratio control filters, and so on.

In some embodiments the assignment of reverberator outputs to loudspeaker channels happens during configuration of the reverberator. The assignment can be stored during configuration and provided to the reverberant signal router.

In some embodiments, the output is a multichannel loudspeaker setup (such as 5.1 or 7.1+4 multichannel loudspeaker setup). In that case, the processing proposed in FIG. 2 can be modified by using the loudspeaker positions of the actual loudspeakers as the loudspeaker setup θₗₛ(i), ϕₗₛ(i), and omitting the binaural renderer, and reproducing the re-arranged reverberant audio signals sᵣₑᵥ₋ᵣₑₐᵣᵣ(n, i) from the corresponding loudspeakers of the loudspeaker setup. Referring to FIG. 15, in the case of loudspeaker output, instead of Binaural renderer 209/1959 there will be loudspeaker renderer (or panner) which in the simplest case will just pass through the loudspeaker signals to a loudspeaker signal combiner which will replace the Binaural signal combiner 1967. Correspondingly, the direct sound part is spatialized with a panner such as VBAP implemented instead of the HRTF processor 1963.

In some embodiments, instead of arranging the delay lines as proposed above to provide maximal width to the reproduced reverberated sound image, the delay lines are arranged such that the maximal width is created along the longest dimension of a (physical or virtual) room. This can be particularly advantageous if head tracking is applied to the reverberated signals, so that they remain fixed to world coordinates as the listener head rotates. In this embodiment, the method is otherwise as above, but the two initial directions are selected to the opposite directions on the longest dimension of a virtual or physical space. Say, for example, that the space is longest along the x dimension. Then, the shortest delay line can be assigned to the direction towards the positive x axis, and the next shortest delay line assigned to the direction towards the negative x axis.

Another example is when head tracking is utilized and instead of maximum wideness of the reverberation it is desired that the reverberation sounds equally wide towards all directions. In this case the algorithm for assigning reverberator outputs to loudspeakers does not pick the farthest loudspeaker channel as the next channel but selects the next loudspeaker channel which is free and sufficiently far from the previous selected channel. Sufficiently far can be determined by a threshold which can be expressed, e.g., as degrees. A suitable threshold can be, for example, 90 degrees.

In some embodiments, there are N separate reverberators instead of a single multichannel reverberator. In this case, the reverberators can be arranged in the order of increasing delay that they cause to the signal. The method can then operate as described above.

In some embodiments, the loudspeaker positions are nearly uniformly distributed on a sphere. The sorted reverberator outputs are routed to the following output loudspeaker positions:
OutputDirection {90, 0},
OutputDirection {−90, 0},
OutputDirection {114, 20},
OutputDirection {−60, −6},
OutputDirection {85, −44},
OutputDirection {−130, −21},
OutputDirection {49, 41},
OutputDirection {−67, 52},
OutputDirection {154, −9},
OutputDirection {−48, −55},
OutputDirection {19, −31},
OutputDirection {−162, 21},
OutputDirection {151, 73},
OutputDirection {−9, 20},
OutputDirection {180, −63},

The following describes potential Matlab code illustrating the maximally wide algorithm for the example loudspeaker configuration.

```
  clf;
  clear all;
  azi = [0, 45, 90, 135, 180, −135, −90, −45, 45, 135, −135, −45, 45,
135, −135, − 45].‘;
  ele = [0, 0, 0, 0, 0, 0, 0, 0, 30, 30, 30, 30, −30, −30, −30, −30]’;
  azi = round(azi);
  ele = round(ele);
  IsPosSph = [azi, ele, ones(size(azi))];
  [x,y,z] = sph2cart(deg2rad(azi), deg2rad(ele), IsPosSph(:,end));
  IsPosCart = [x, y, z];
  plot3(x, y, z, ‘ko’, ‘LineWidth’, 2);
  % vector from origin to front
  % origin is 0 0 0, front is 0 0 1
  [fx, fy, fz] = sph2cart([0;0], [0;0], [0;1]);
  hold on;
  plot3(fx, fy, fz, ‘r−’, ‘LineWidth’, 2);
  [spherex, spherey, spherez] = sphere(20);
  plot3(spherex, spherey, spherez, ‘m’, ‘LineWidth’, 1);
  rotate3d on;
  N = size(IsPosSph, 1);
  distM = zeros(N,N);
  for rid = 1:N
    for cid = 1:N
      distM(rid,cid) = sqrt((x(rid)−x(cid))\hat{ }2 + (y(rid)−y(cid))\hat{ }2 + (z(rid)−
z(cid))\hat{ }2);
    end
  end
  assignM = zeros(N,1);
  startPol = [90, 0, 1];
  [startx, starty, startz] = sph2cart(deg2rad(startPol(1)),
deg2rad(startPol(2)), startPol(3));
  d = abs(IsPosCart − [startx, starty, startz]);
  [minVal,currId] = min(sum(d,2));
  plot3(IsPosCart(currId, 1), IsPosCart(currId, 2), IsPosCart(currId,3),
‘k*’, ‘LineWidth’, 8);
  degStr = sprintf(‘%d, %d’, startPol(1), startPol(2));
  t = text(IsPosCart(currId, 1), IsPosCart(currId, 2),
IsPosCart(currId,3)+0.1, degStr, ‘FontSize’, 18);
  distM(:,currId) = zeros(N,1);
  disp(startPol);
  disp(‘ChannelIdx LsIdx’)
  disp([1 currId]);
  assignM(currId) = 1;
  for id = 2:N
    [maxVal, currId] = max(distM(currId, :));
    distM(:,currId) = zeros(N,1);
    plot3(IsPosCart(currId, 1), IsPosCart(currId, 2), IsPosCart(currId,3),
‘k*’, ‘LineWidth’, 8);
    degStr = sprintf(‘%d, %d’, IsPosSph(currId, 1), IsPosSph(currId, 2));
    t = text(IsPosCart(currId, 1), IsPosCart(currId, 2),
IsPosCart(currId,3)+0.1, degStr, ‘FontSize’, 18);
    disp(‘LS position’);
    disp(IsPosSph(currId,:));
    disp(‘ChannelIdx LsIdx’)
    disp([id currId]);
    assignM(currId) = id;
  end
  disp(assignM);
```

In some embodiments the assignment of ‘virtual loudspeaker’ channels in addition to finding a ‘virtual loudspeaker’ channel position having a distance larger than a threshold to the previous selected one inspects that the selected ‘virtual loudspeaker’ positions are not too close to each other. In other words the method is configured to inspect the potential next ‘virtual loudspeaker’ position is not closer than a threshold (for example 10 degrees azimuth/elevation) to an already selected ‘virtual loudspeaker’ position. Alternatively, the method can first pre-process the loudspeaker setup and disable ‘virtual speakers’ which are too close to other speakers (so that they cannot be selected during the procedure).

In the above examples the assignment of ‘virtual loudspeaker’ channels is based on an ordering of the channels defined by the delay length of each channel. However in some embodiments the assignment is implemented without an ordering. For example in some embodiments rather than ordering each channel, groups of channels are selected based on a delay length range and then assigned on a group by group basis so that channels with similar delay lengths are assigned as a group to be spaced from each other.

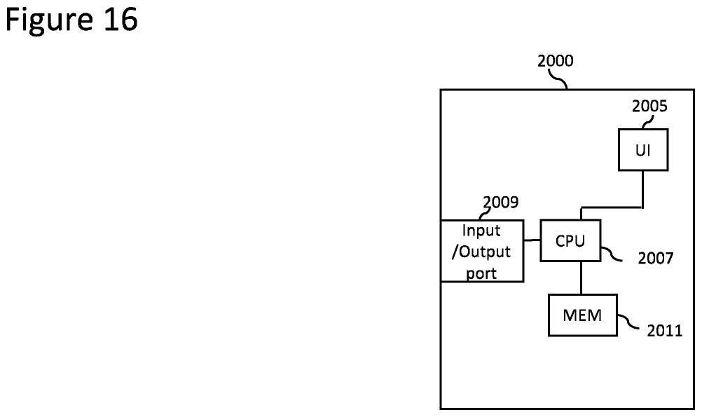

With respect to FIG. 16 an example electronic device which may be used as any of the apparatus parts of the system as described above. The device may be any suitable electronics device or apparatus. For example in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus for applying reverberation to at least one audio signal, the apparatus comprising:
at least one processor; and
at least one memory storing instructions that, when executed with the at least one processor, cause the apparatus at least to:
obtain the at least one audio signal;
obtain a number of sound reproduction positions for playback audio in relation to a listening position;
determine a reverberator comprising a number of channels, wherein the number of channels is configured with at least two respective delay lines having different delays;
assign the reverberator channels to the sound reproduction positions based on the delays of the number of channels; and
process the at least one audio signal with the reverberator based on the assigned channels to generate reverberated playback audio signals for the listening position.

2. The apparatus as claimed in claim 1, wherein the instructions, when executed with the at least one processor, cause the apparatus to:
determine directional filter pairs associated with the sound reproduction positions for playback audio; and
filter the reverberated playback audio signals with the associated directional filter pairs to generate reverberated playback binaural audio signals.

3. The apparatus as claimed in claim 1, wherein the instructions, when executed with the at least one processor, cause the apparatus to:
order the channels based on the delays; and
assign the channels to the sound reproduction positions based on the ordering of the channels.

4. The apparatus as claimed in claim 1, wherein the instructions, when executed with the at least one processor, cause the apparatus to assign channels with similar delay lengths to sound reproduction positions distributed away from each other.

5. The apparatus as claimed in claim 4, wherein the instructions, when executed with the at least one processor, cause the apparatus to:
assign a first of the ordered channels to a first sound reproduction position; and
assign succeeding ordered channels to sound reproduction positions further than a threshold distance away from a preceding assigned sound reproduction position.

6. The apparatus as claimed in claim 5, wherein the instructions, when executed with the at least one processor, cause the apparatus to assign succeeding ordered channels to a currently unassigned sound reproduction position furthest away from an immediately preceding assigned sound reproduction position.

7. The apparatus as claimed in claim 1, wherein the instructions, when executed with the at least one processor, cause the apparatus to:
determine the number of sound reproduction positions is fewer than the number of channels; and
assign more than one channel to at least one of the sound reproduction positions such that is the channels are assigned to one of the sound reproduction positions.

8. The apparatus as claimed in claim 1, wherein the instructions, when executed with the at least one processor, cause the apparatus to:
determine the number of sound reproduction positions is greater than the number of reverberator channels;
generate at least one further reverberator channel; and
assign the at least one further reverberator channel to at least one of the sound reproduction positions which have not been assigned previously.

9. The apparatus as claimed in claim 4, wherein the instructions, when executed with the at least one processor, cause the apparatus to:
obtain at least one dimension of a scene within which the reverberation is associated with; and
determine at least one time delay for a reflection path based on the at least one dimension of the scene, wherein the delay-line delay is based on the determined at least one time delay for the reflection path.

10. The apparatus as claimed in claim 9, wherein the instructions, when executed with the at least one processor, cause the apparatus to assign the channels to the sound reproduction positions further based on the at least one dimension of the scene.

11. The apparatus as claimed in claim 10, wherein the instructions, when executed with the at least one processor, cause the apparatus to:
select two initial directions from the sound reproduction positions based on a longest dimension of the scene, such that the two initial directions are separated with the longest dimension;
assign a first channel to a first of the two initial directions from the sound reproduction positions; and
assign a second channel to a second of the two initial directions from the sound reproduction positions, wherein the respective delay-line delay of the second channel is similar to or equal to the respective delay-line delay of the first channel and the respective delay-line delay of the second channel and the respective delay-line delay of the first channel are the two shortest delay delay-lines.

12. The apparatus as claimed in claim 3, wherein the instructions, when executed with the at least one processor, cause the apparatus to:
assign a first ordered channel to a first sound reproduction position; and
assign a succeeding ordered channel to an unassigned sound reproduction position a minimum distance away from a preceding assigned sound reproduction position.

13. The apparatus as claimed in claim 3, wherein the reverberator comprises the number of reverberators, the number of reverberators comprising a single channel, and wherein the instructions, when executed with the at least one processor, cause the apparatus to arrange the number of reverberators in the order of increasing delay-line delay.

14. The apparatus as claimed in claim 1, wherein the reverberator comprises a feedback delay network reverberator.

15. The apparatus as claimed in claim 1, wherein the channels are configured with respective delay lines having different delays.

16. The apparatus as claimed in claim 15, wherein the channels are configured with respective delay lines having different delays which are made mutually prime.

17. A method for an apparatus for applying reverberation to at least one audio signal, the method comprising:
obtaining the at least one audio signal;
obtaining a number of sound reproduction positions for playback audio in relation to a listening position;
determining a reverberator comprising a number of channels, wherein the number of channels is configured with at least two respective delay lines having different delays;
assigning the reverberator channels to the sound reproduction positions based on the delays of the number of channels; and
processing the at least one audio signal with the reverberator based on the assigned channels to generate reverberated playback audio signals for the listening position.

18. The method as claimed in claim 17, further comprising:
determining directional filter pairs associated with the sound reproduction positions for playback audio; and
filtering the reverberated playback audio signals with the associated directional filter pairs to generate reverberated playback binaural audio signals.

19. The method as claimed in claim 17, wherein assigning the channels to the sound reproduction positions based on the delays of the channels comprises:
ordering the channels based on the delays; and
assigning the channels to the sound reproduction positions based on the ordering of the channels.

20. The method as claimed in claim 17, wherein assigning the channels to the sound reproduction positions based on the delays comprises assigning channels with similar delay lengths to sound reproduction positions distributed away from each other.

21. (canceled)
